(19) United States
(12) Patent Application Publication
(10) Pub. No.: US 2019/0382561 A1
(43) Pub. Date: Dec. 19, 2019

(54) COLLOIDAL NANOMATERIAL/POLYMOLECULAR SYSTEM NANOCOMPOSITES, AND PREPARATION METHODS

(71) Applicants: CENTRE NATIONAL DE LA RECHERCHE SCIENTIFIQUE, PARIS (FR); UNIVERSITÉ DE STRASBOURG, STRASBOURG (FR)

(72) Inventors: Izabela JANOWSKA, STRASBOURG (FR); Lai TRUONG-PHUOC, STRASBOURG (FR); Housseinou BA, STRASBOURG (FR); Cuong PHAM-HUU, STRASBOURG (FR)

(21) Appl. No.: 16/349,078

(22) PCT Filed: Nov. 9, 2017
(86) PCT No.: PCT/FR2017/053064

§ 371 Date: Sep. 9, 2019

(30) Foreign Application Priority Data
Nov. 10, 2016 (FR) 1660935

(51) Int. Cl. C08L 3/02; C08L 5/12; C08L 89/00; C08K 3/04; C08K 3/34; C08L 99/00

(52) U.S. Cl. CPC C08L 3/02; C08L 5/12; C08L 89/00; C08K 3/046; C08K 3/346; C08K 3/042; B82Y 30/00; C08K 2201/011; C08L 2203/16; C08L 2203/20; C08K 2201/001; C08K 2201/005; C08K 2201/01; C08L 99/00

(57) ABSTRACT

The present invention relates in particular to a laminar nanomaterial/natural polymolecular system nanocomposite in which the nanomaterial is an exfoliated and/or dispersed laminar material, and the polymolecular system has a hydrophilic-lipophilic balance (HLB)≥8. The present invention also relates to a laminar nanomaterial/natural polymolecular system nanocomposite colloid in a polar solvent, in which the concentration of exfoliated/dispersed nanomaterial in the polar solvent is ≥1 g/L, and in which the nanomaterial is an exfoliated and/or dispersed laminar material, and the natural polymolecular system has a hydrophilic-lipophilic balance ≥8. The present invention also relates to a process for preparing a nanocomposite colloid according to the invention, and also to a process for exfoliating and/or dispersing a laminar material. The present invention also relates to a nanocomposite or nanocomposite colloid capable of being obtained by a process according to the invention, and also to the use thereof, in particular for the manufacture of inks, conductive coatings such as a conductive paint, catalysts such as metal-free catalysts for the selective dehydrogenation of ethylbenzene or styrene, or energy storage systems; or else as an additive in polymers and composites, as a catalyst support, in the manufacture of electrodes, of conductive films, in the production of layers for mechanical reinforcement, in tribology, for the formation of conductive networks for example by self-assembly, or in applications in batteries, supercapacitors, and applications in magnetism.

### TECHNICAL FIELD

The present invention relates especially to a nanocomposite consisting of a laminar nanomaterial and of a natural polymolecular system in which the nanomaterial is an exfoliated and/or dispersed laminar (for example graphitic) material, and the polymolecular system has a hydrophilic/lipophilic balance (HLB)≥28.

The present invention also relates to a colloid of laminar nanomaterial/natural polymolecular system nanocomposite in a polar solvent, in which the concentration of exfoliated/dispersed nanomaterial in the polar solvent is ≥1 g/L, and in which the nanomaterial is an exfoliated and/or dispersed laminar (for example graphitic) material, and the natural polymolecular system has a hydrophilic/lipophilic balance ≥8.

The present invention also relates to a process for preparing a nanocomposite colloid according to the invention, and also to a process for exfoliating and/or dispersing a laminar, for example graphitic, material.

The present invention also relates to a nanocomposite or nanocomposite colloid that may be obtained via a process according to the invention, and also to the use thereof, especially for the manufacture of conductive inks, conductive coatings such as a conductive paint, catalysts such as metal-free catalysts for the selective dehydrogenation of ethylbenzene or styrene, or energy storage systems; or alternatively as an additive in polymers and composites, as a catalytic support, in the manufacture of electrodes and conductive layers, in the manufacture of transparent electrodes and layers for facilitating charge transport, in the manufacture of conductive films, in the production of layers for mechanical reinforcement, in tribology, for the formation of conductive networks, for example by self-assembly, or in applications in batteries, supercapacitors, and applications in magnetism.

In the description hereinbelow, the references in square brackets ([ ]) refer to the list of references presented after the examples.

### Prior Art

Graphene is a two-dimensional (single-plane) carbon crystal, the stacking of which constitutes graphite. It has excellent electronic properties and is potentially available in large amount by exfoliation of graphite. Graphene constitutes a basic construction unit in a large family of nano-graphitic materials generally of very high specific surface area, and which combine a certain number of properties such as high electrical and thermal conductivity, good mechanical strength and chemical resistance, specific adsorption sensitivity and strength, or light absorption, affording access to numerous applications in high-performance composites, (opto)electronics, energy storage and transfer, catalysis or the biomedical field. The structure-property-application relationship is, however, an important consideration and the specific properties of graphene will depend on the way in which it is geometrically and chemically fashioned. Nanocarbons such as tubes, tapes, dots, and multilayer graphenes are based on the rolling-up, cutting and stacking of graphene leaflets. In contrast with certain fields, in which large-sized graphene leaflets (multi-leaflet) of high crystallinity or carbon nanofibers with a high aspect ratio are determining factors for the formation of continuous paths which readily propagate the electrical or mechanical properties, small-sized leaflets with a high oxygen content may be beneficial for other applications such as biomedical applications or catalysis. In the latter case, the introduction of defects or of heteroatoms having a different electronegativity not only increases the capacity for attachment toward active metal nanoparticles, but also makes the graphitic materials active themselves. This concerns the field of metal-free catalysis, which, for environmental (and economic) reasons, is the subject of increased interest in the scientific and industrial community. The most important examples comprise vertically aligned N-doped carbon nanotubes which are highly active in the oxygen reduction reaction [1], and also nanodiamonds which are very promising as catalysts for the selective dehydrogenation of ethylene benzene to styrene [2].

Given the important perspectives of these nanocarbons, the choice of their synthesis is determined not only by the properties associated with their structure, but also by economic and environmental considerations. For application sectors in which a high yield of nanocarbons with flat structures is required, descending methods, including various methods for the exfoliation of graphite materials, are desirable, in particular when the production of multilayer graphene is not detrimental, or even is preferable. This is particularly true for efficient methods of exfoliation in liquid medium of muitilayer graphene, and which can be implemented on an industrial scale, for application in composites, energy storage and conductive coating sectors, in which graphene dispersions of high concentration are often of great interest (inks). Significant work has especially been devoted to the liquid exfoliation of graphite, of expanded graphite or (less commonly) of graphite fibers in organic solvents with a suitable surface tension (˜40 mN/m), or with electronic properties which allow solvent-graphene interactions by charge transfer. The advantages of methods in aqueous medium relative to organic solvents are mainly associated with the environmental and practical aspects, whereas recourse to surfactants is necessary due to the hydrophobic nature of graphite. Typically, the surfactant molecules used generally comprise porphyrins [3,4], polymers [5, 6, 7], or large-sized conjugated polycyclic aromatic hydrocarbons (PAHs) such as pyrenes [5,8], which are of high toxicity. On the other hand, highly oxidative graphite intercalation products have been used in the case of exfoliation of graphite oxide in water to give graphene oxide, in which the conjugated C═C conductive network must, however, subsequently be restored, which is reflected by a laborious overall process and harsh reaction conditions. [9,10]

There is thus a real need for a process which overcomes the abovementioned defects, drawbacks and obstacles of the prior art, in particular a process for exfoliating and/or dispersing in aqueous medium laminar materials, for example graphitic materials such as graphite, in very good yields and at very high concentrations.

### DESCRIPTION OF CERTAIN ADVANTAGEOUS EMBODIMENTS OF THE INVENTION

The aim of the present invention is, precisely, to meet this need by providing a process for exfoliating and/or dispersing a laminar material, for example a graphitic material, characterized in that it comprises the exposure of a laminar material to a source of shear forces in a polar solvent in the presence of a natural polymolecular system with a hydrophilic/lipophilic balance ≥8.

Said process leads to the formation of a nanocomposite consisting of the material in nanometric form (nanomaterial) and the natural polymolecular system, preferably in the form of a colloid.

Preferably, when the nanomaterial is graphene (mono-leaflet or multi-leaflet), the natural polymolecular system is not a gum arabic, a guar gum, a locust bean gum, a carrageenan, a xanthan gum, or a combination thereof, in particular when the process is performed to form a colloid with a concentration of monolayer or multilayer graphene ≤0.5 to 1 g/L as nanocomposite.

The process according to the invention involves two phenomena depending on the nature of the laminar material: exfoliation and dispersion. These two phenomena are associated but do not necessarily take place together with all the laminar materials that may be used in the process of the present invention. In general, the process of the invention makes it possible to obtain a colloidal dispersion of exfoliated and/or dispersed nanomaterials, in the form of a colloidal nanocomposite with the natural polymolecular system of HLB≥8. Irrespective of the nature of the laminar material used in the process, a dispersion is obtained, and this is achieved with yields and concentrations that are significantly higher than those of the dispersion processes known from the prior art.

Thus, according to another aspect, the present invention also relates to a process for preparing a nanocomposite colloid, comprising the exfoliation and/or dispersion of a laminar material in a polar solvent in the presence of a natural polymolecular system with a hydrophilic/lipophilic balance ≥8 under the action of a source of shear forces.

The source of shear forces may be a sonicator, an emulsifying machine, a homogenizer or a system for generating turbulence or vibrations, a mechanical stirrer. Preferably, the source of shear forces is a sonicator, such as an ultrasonic bath or an ultrasonic finger assisted with a mechanical stirrer. Advantageously, the sonicator may be used at a frequency of from 45 to 65 Hz, preferably 50 to 60 Hz. Advantageously, the sonicator may be used with a power of from 30 to 50 W, preferably 35 to 45 W, preferably 40 W±2 W.

Preferably, for the abovementioned processes, the action of the source of shear forces may be coupled with mechanical stirring. Advantageously, the action of the source of shear forces, optionally coupled with mechanical stirring, may be performed for 5 minutes to 50 hours, preferably for 15 minutes to 5 hours, more preferentially for 1 to 3 hours.

Depending on the nature of the materials used and the intended applications, the parameters of the process according to the invention, especially the duration of application of the shear forces, and/or the intensity of these forces may be modified so as to obtain nanocomposite colloids that are increasingly exfoliated and/or dispersed, or even increasingly functionalized. By way of example, prolongation of the time for exfoliation of expanded graphite from 2 hours to 5 hours gives multilayer graphenes with smaller lateral sizes since they are more dispersed, and also having a higher oxygen content.

The amounts of laminar material, of starting natural polymolecular system, the ratio between the two and the polar solvent may be adjusted as a function of the desired final consistency (solution, gel, paste, etc.), and of the concentration of exfoliated/dispersed nanomaterial targeted in the final colloid.

Advantageously, the mass ratio: amount of laminar material/amount of natural polymolecular system may be between 50:50 and 99:1, preferably between 70:30 and 99:1, even more preferably between 85:15 and 95:5 and better still 88:12 and 92:8, for example when the intended applications are conductive inks. The mass ratio:amount of laminar material/amount of natural polymolecular system may be between 50:50 and 30:70, for example when the intended applications are supercapacitor electrodes. The mass ratio:amount of laminar material/amount of natural polymolecular system may be between 0.1:99.9 and 10:90, for example when the intended applications are “reverse” nanocomposites containing the polymolecular system in excess.

By way of example, use may be made of a ratio x:y:z of about 10:1:10, x representing the amount of starting laminar material in mg, y representing the amount of starting natural polymolecular system in mg, and z representing the volume of polar solvent in ml. This ratio may be particularly advantageous when the natural polymolecular system is one or more proteins, such as hemoglobin, myoglobin or bovine serum albumin, in particular for the production of colloids in the form of fluid colloids.

To obtain colloids in ink form (concentration of between˜5-30 g/L), a ratio x:y:z of about 10:1:2 may be used, x, y and z having the same meaning as above.

To obtain colloids in foam/gel form, a ratio x:y:z of about 40:4:1 may be used, x, y and z having the same meaning as above (concentration of between ˜30-70 g/L).

To obtain colloids in paste form (concentration >70 g/L), a ratio x:y:z of about 80:8:1 may be used, x, y and z having the same meaning as above.

Needless to say, the above ratios may be modified as a function of the intended application, and the desired colloid consistency.

According to one variant, the abovementioned processes may also comprise a step of isolating the colloid obtained. For example, the isolation may be a filtration, decantation and/or centrifugation of the colloid obtained. The abovementioned processes may also comprise any other step allowing the separation of the constituents of the colloid having different morphologies, for example multilayer graphene with varied layer size and/or number. Such a separation of the constituents of the colloid according to the invention may be performed, for example, by a non-chemical separation step, such as decantation, centrifugation, a source of vibration, or by combustion.

Advantageously, the abovementioned processes may comprise one or more repetitions of the successive steps:
a) exfoliation and/or dispersion of a laminar material in a polar solvent in the presence of a natural polymolecular system of hydrophilic/lipophilic balance ≥8 under the action of a source of shear forces, optionally coupled with mechanical stirring, for 5 minutes to 50 hours, preferably for 15 minutes to hours, more preferentially for 1 to 3 hours;
b) isolation, for example by filtration, decantation and/or centrifugation, of the colloid obtained, or any other step allowing the separation of the constituents of the colloid having different morphologies.

For example, the succession of step a) and b) may be repeated several times, subjecting the material obtained on conclusion of step b) of iteration n to the successive steps a) and then b) of iteration n+1.

According to one variant, the abovementioned processes may comprise a step of concentrating the colloid obtained. This concentration step may be performed, for example, by evaporation of the polar solvent, and makes it possible especially to achieve higher concentrations of exfoliated and/or dispersed nanomaterial in the colloid. The evaporation of the polar solvent may be performed without substantial aggregation of the nanocomposite.

The evaporation of the polar solvent may be performed until the solvent has been totally removed, thus resulting in a dry solid nanocomposite, which may be subsequently redispersed in a solvent, preferably a polar solvent such as H₂O, a C1 to C8 and preferably C2 to C4 alcohol, or a mixture thereof; preferably H₂O, i-PrOH, or a mixture thereof; preferably H₂O.

Thus, the processes according to the present invention may also comprise a step of drying of the colloid (evaporation of the polar solvent), and optionally a step of redispersion of the solid nanocomposite thus obtained in a solvent, preferably a polar solvent.

According to one variant, the abovementioned processes may also comprise a step of separating or destroying the natural polymolecular system of the colloid. Preferably, it may be a step of chemical separation or destruction, for example by acidic or basic hydrolysis. By way of example, the natural polymolecular system may be partially or totally removed by treatment with aqua regia or nitric acid at reflux. The abovementioned processes may also comprise a step of separating out the solvent. The abovementioned processes may also comprise a step of calcination at high temperature, preferably at a temperature T≥200° C., under an inert atmosphere or between 60 and 600° C. under an oxygenated atmosphere (for example in the presence of air or of dioxygen). The term “inert atmosphere” means an environment in which air-sensitive or moisture-sensitive reactions may be performed, for example argon, helium or nitrogen. Advantageously, this calcination step may make it possible to complete the removal and/or carbonization of the natural polymolecular system, especially if a preliminary step of separation or destruction by acidic or basic treatment has not made it possible to remove 100% of the natural polymolecular system.

Advantageously, the exfoliation and/or dispersion under the action of a source of shear forces may be performed in the presence of at least one metal salt, at least one source of dopant, at least one pore-forming agent, at least one water-soluble polymer or monomer of a water-soluble polymer, and/or a pH modifier. For example, the metal salt may be iron nitrate. Advantageously, the dopant may be nitrogen, boron or sulfur (the source of dopant may be, for example, ammonium carbonate, urea or thiourea). The pore-forming agent may be, for example, polystyrene beads. The water-soluble polymer or monomer of a water-soluble polymer may be, for example, polymethyl methacrylate (PMMA), polyethylene oxide, polyacrylamide, polyvinylpyrrolidone (PVP), latex, polyvinyl acetate (PVA) or polyethylene glycol (PEG).

The pH modifier may be an inorganic base such as NaOH or KOH, or inorganic acids, for instance HCl. Preferably, the pH modifier will be used under conditions that do not lead to hydrolysis or degradation of the natural polymolecular system and/or of the nanocomposite. Typically, it will be a matter of adjusting the temperature conditions and the concentration of the pH modifier to moderate values to avoid any hydrolysis or degradation.

Natural Polymolecular System

In general, the abovementioned natural polymolecular system with a hydrophilic/lipophilic balance (HLB)≥8 may be a natural polymolecular system of plant, animal, fungal, algal or crustacean origin. Advantageously, the natural polymolecular system with a hydrophilic/lipophilic balance (HLB)≥8 may be chosen from phosphoglycerides, omega-3 fatty acids, plant extracts (preferably aqueous or aqueous-alcoholic extracts) or biopolymers selected from proteins, polysaccharides or natural gums, preferably derived from a source of plant, animal, fungal, algal or crustacean origin. Thus, polynucleotides (RNA, DNA) and monomolecular biomolecules, such as flavin, are excluded from the context of the present invention.

The hydrophilic/lipophilic balance may be determined by calculations based on a Griffin-Davis concept according to the equation: HLB=Σ (number of hydrophilic groups)−Σ(number of lipophilic groups)+7, or, preferably, by a simplified equation: HLB=0.2*(molecular mass of the hydrophilic part)/(total molecular mass of the natural polymolecular system). In practice, all polymolecular systems of natural origin which are soluble in water, or which have at least a low solubility in water, generally have a hydrophilic/lipophilic balance that is adequate in the context of the invention (i.e. ≥8). This is the case, for example, for polymolecular systems derived from plant extracts, in particular aqueous or aqueous-alcoholic extracts.

Advantageously, the natural polymolecular system may be a protein. For example, it may be hemoglobin, myoglobin or bovine serum albumin. These proteins may be extracted/obtained via any suitable method known in the prior art. Hydrophobins are excluded from the context of the invention, insofar as this class of fungal proteins containing about a hundred amino acids is known for its capacity to form a hydrophobic film on surfaces where they form/self-assemble, especially at the air/water interface.

Advantageously, the natural polymolecular system may be a polysaccharide, preferably having hydrocolloid properties. For example, it may be maltodextrin, pectins such as pectin E 440, alginates or gelatin.

Advantageously, the natural polymolecular system may be lecithin, casein or chitin.

Advantageously, the natural polymolecular system may be a natural source of omega-3 fatty acid. For example, it may be a fish liver oil, such as cod, sardine, salmon or herring liver oil, or a linseed or rapeseed oil.

Advantageously, the natural polymolecular system may be any plant extract that may be obtained via the methods that are conventional in the field. Said extract may be, for example, plant extracts obtained by hydrodistillation (steam entrainment), by pressing, using volatile organic solvents such as petroleum ether, hexane, ethyl ether, ethyl alcohol, acetone, carbon dioxide, methylene chloride, benzene, toluene, etc., or other types of extraction such as cold maceration, hot digestion, boiling decoction, lixiviation or cold percolation or percolation under pressure, hot and then cold infusion, and alcoholic tincturing. They may be raw plant extracts or refined plant extracts obtained from raw extract fractionations (for example, the usual techniques to do this include cryoconcentration, distillation under reduced pressure, ultrafiltration, reverse osmosis, etc.). In general, the whole plant is not extracted, but only certain parts such as the roots, rhizomes, wood, bark, leaves, flowers, floral buds, fruits, seeds, fruit juice, or plant excretions (gums or exudates). Advantageously, the natural polymolecular system may be an extract of okra (Abelmoschus esculentus) or an extract of the ground fruit and leaves of African baobab (Adansonia digitata), preferably an aqueous or aqueous-alcoholic extract.

Advantageously, the dried leaves and pods may be ground and used directly as natural polymolecular system, without recourse to a preliminary extraction (the plant components are extracted into the polar solvent in the course of the implementation of the process).

Advantageously, the natural polymolecular system may be a gum preferably having hydrocolloid properties. For example, it may be gum tragacanth, karaya gum, tara gum, gellan gum, konjac gum or agar-agar.

Preferably, the natural polymolecular system may comprise phosphoglycerides, omega-3 fatty acids, plant extracts (preferably aqueous or aqueous-alcoholic extracts), or biopolymers selected from natural gums, polysaccharides or proteins.

Advantageously, the natural polymolecular system may be a nonionic compound.

Advantageously, the nonionic natural polymolecular system may be hemoglobin, myoglobin, bovine serum albumin, maltodextrin, agar-agar or an extract of okra or of the ground fruit and leaves of African baobab, tannic acid, egg white, karaya gum or gellan gum.

Preferably, the natural polymolecular system may be hemoglobin, myoglobin, bovine serum albumin, maltodextrin, agar-agar or an extract (preferably an aqueous or aqueous-alcoholic extract) of okra or of the ground fruit and leaves of African baobab.

Advantageously, at least two natural polymolecular systems with different hydrophilic/lipophilic balance (HLB)≥values and ≥8, among any two of the natural polymolecular systems described previously, may be used. Preferably, they may be two natural polymolecular systems chosen from hemoglobin, myoglobin, bovine serum albumin, maltodextrin, agar-agar or an extract (preferably an aqueous or aqueous-alcoholic extract) of okra or of the ground fruit and leaves of African baobab.

Laminar Material

Advantageously, the laminar material used in the abovementioned processes may be chosen from laminar carbon-based materials, laminar nitrogen-based materials, lamellar inorganic materials, silicon-based pseudo-graphitic carbon-based materials, or laminar minerals.

Advantageously, the laminar material may be a laminar carbon-based material, for example a graphitic material, such as graphite which is preferably expanded, carbon nanofiber bundles, nanodiamonds, or nanohoms.

Advantageously, the laminar material may be a laminar nitrogen-based material such as carbon nitride or boron nitride.

Advantageously, the material may be a silicon-based pseudo-graphitic carbon-based material, such as silicon carbide.

Advantageously, the laminar material may be a lamellar inorganic material of the family of metal chalcogenides such as WS₂, MOS₂, WSe₂ or GaSe, of semi-metals (for example WTa₂, TcS₂), of superconductors (for example NbS₂, TaSe₂), or else topological insulators and thermoelectric materials (for example Bi₂Se₃, Bi₂Te).

Advantageously, the laminar material may be a laminar mineral (also known as a “lamellar mineral”). Lamellar minerals include clay, potter's clay and all minerals in general which can be cleaved along flat surfaces, including:
for example, gypsum, muscovite, calcite, galene, halite;
the family of “laminar oxides” in general, for example V₂O₅, MoO₃, MnO₂, LaNb₂O₇, TiO₂;
lamellar phyllosilicates, such as talc (Mg₃Si₄O₁₀ (OH)₂), micas and montmorillonite. Phyllosilicates consist of a regular stack of elementary leaflets of crystalline structure, the number of which varies from a few units to a few thousand units. Among the phyllosilicates, the group especially comprising talc, mica and montmorillonite is characterized in that each elementary leaflet consists of an association of two layers of tetrahedra located on either side of a layer of octahedra. This group corresponds to the phyllosilicates 2:1, of which smectites especially form part. In view of their structure, phyllosilicates 2:1 are also termed as being of T.O.T. (tetrahedron-octahedron-tetrahedron) type. Lamellar phyllosilicates are used, for example, in the form of fine particles in many industrial sectors, such as: thermoplastics, elastomers, paper, paint, varnishes, textile, metallurgy, pharmaceuticals, cosmetics, plant-protection products or fertilizers in which phyllosilicates such as talc are used, by incorporation into a composition, as inert filler (for their chemical stability or else for the dilution of active compounds of higher cost) or functional fillers (for example for reinforcing the mechanical properties of certain materials).
all the oxides also often known as “lamellar” of general formula AxMO₂, in which A=alkali metal ion, M=transition metal element and x is between 0.5 and 1 (for example NaxMO₂, NaxVO₂, LiCoO₂);
lamellar perovskite oxides, for instance M [La₂Ti₃O₁₀] in which M=Co, Cu, Zn;
“lamellar double hydroxides” (or “LDH”) (for example Mg₆Al₂(OH)₁₈); or
lamellar metal halides (for example Cdl₂, MgBr₂).

Lamellar oxides may advantageously find an application in batteries, supercapacitors, and applications in magnetism.

Advantageously, the laminar nanomaterial may be a laminar nanomaterial which is intercalated (for example with cations or anions), such as Na⁺, Li+, K⁺, Ca²⁺, ClO₄⁻ or metal halides MClx (for example M=Zn, Ni, Cu, Al, Fe in which x=2-4).

Advantageously, at least two different laminar materials, from among any two of the laminar materials described previously, may be used.

Polar Solvent

Advantageously, the polar solvent may be H₂O, a C1 to C8 and preferably C2 to C4 alcohol, or a mixture thereof; preferably H₂O, i-PrOH, or a mixture thereof; preferably H₂O.

Advantageously, the laminar material may be a laminar carbon-based material, for example a graphitic material, such as graphite which is preferably expanded, carbon nanofiber bundles, nanodiamonds, or nanohoms, a lamellar inorganic material of the family of metal chalcogenides such as WS₂, MoS₂, WSe₂ or GaSe, of semi-metals (for example WTa₂, TcS₂), of superconductors (for example NbS₂, TaSe₂), or of topological insulators and thermoelectric materials (for example Bi₂Se₃, Bi₂Te), and the natural polymolecular system may be nonionic and chosen, for example, from a protein such as hemoglobin, myoglobin, bovine serum albumin, a polysaccharide such as maltodextrin, agar-agar or a plant extract such as an extract of ocra or of the ground fruit and leaves of African baobab. Preferably, when the exfoliated laminar carbon-based material is graphene (mono-leaflet or multi-leaflet), the natural polymolecular system is not a hydrophobin, lysozyme, a gum arabic, a guar gum, a locust bean gum, a carrageenan, a xanthan gum, or a combination thereof.

Advantageously, the process may be a process for exfoliating and/or dispersing a laminar material, chosen from the group comprising a laminar carbon-based material, such as graphite which is preferably expanded, carbon nanofiber bundles, nanodiamonds, or nanohoms, a lamellar inorganic material of the family of metal chalcogenides such as WS₂, MoS₂, WSe₂ or GaSe, of semi-metals (for example WTa₂, TcS₂), of superconductors (for example NbS₂, TaSe₂), or of topological insulators and thermoelectric materials (for example Bi₂Se₃, Bi₂Te, comprising the exposure of the laminar material to a source of shear forces, optionally coupled with mechanical stirring, in a polar solvent in the presence of a natural polymolecular system with a hydrophilic/lipophilic balance ≥8, which is preferably nonionic and chosen, for example, from a protein such as hemoglobin, myoglobin, bovine serum albumin, a polysaccharide such as maltodextrin, agar-agar or a plant extract such as an extract of ocra or of the ground fruit and leaves of African baobab. Preferably, when the laminar carbon-based material is graphite, the action of the source of shear forces may be coupled with mechanical stirring; or alternatively, when the laminar carbon-based material is expanded graphite, the natural polymolecular system may be nonionic and the action of the source of shear forces may be optionally coupled with mechanical stirring.

Advantageously, the process for preparing a nanocomposite colloid may comprise the exfoliation and/or dispersion of a laminar material chosen from the group comprising a laminar carbon-based material, such as graphite which is preferably expanded, carbon nanofiber bundles, nanodiamonds, or nanohorns, a lamellar inorganic material of the family of metal chalcogenides such as WS₂, MoS₂, WSe₂ or GaSe, of semi-metals (for example WTa₂, TcS₂), of superconductors (for example NbS₂, TaSe₂), or of topological insulators and thermoelectric materials (for example Bi₂Se₃, Bi₂Te) in a polar solvent in the presence of a natural polymolecular system with a hydrophilic/lipophilic balance ≥8, which is preferably nonionic and chosen, for example, from a protein such as hemoglobin, myoglobin, bovine serum albumin, a polysaccharide such as maltodextrin, agar-agar or a plant extract such as an extract of ocra or of the ground fruit and leaves of African baobab under the action of a source of shear forces, optionally coupled with mechanical stirring. Preferably, when the laminar carbon-based material is graphite, which is preferably expanded, the action of the source of shear forces may be coupled with mechanical stirring; or alternatively the natural polymolecular system may be nonionic and the action of the source of shear forces may be coupled with mechanical stirring.

### Definitions

To facilitate the comprehension of the invention, a certain number of terms and expressions are defined below:

For the purposes of the present invention, the term “natural polymolecular system” refers to a macromolecular system of natural origin (derived from plants, animals, fungi, algae or crustaceans) consisting of compounds or species of different molecular sizes and/or of similar but not strictly identical molecular structures, such as biopolymers, natural oils which are sources of fatty acids, polysaccharides, proteins, etc. The natural polymolecular system in the context of the present invention thus consists of a set of molecules of natural origin which are not strictly identical (not isomolecular) and not strictly connected via covalent bonds, but which exist in the system in the form of a collectivity of molecules generally of the same class corresponding to a distribution curve and having a precise biological function in living or natural species in general.

When it refers to a natural polymolecular system within the meaning of the present invention, the term “nonionic” refers to a natural polymolecular system not bearing any net charge, for example which does not become ionized in water.

For the purposes of the present invention, the term “nanomaterial/natural polymolecular system nanocomposite” refers to a composite consisting of a laminar nanomaterial and of a natural polymolecular system.

The terms “laminar material” or “lamellar material” are used interchangeably in the present document and denote, for the purposes of the present invention, a material in which an element or its texture (structure) exists in sheet form. The laminar or lamellar materials within the meaning of the invention include graphitic materials, pseudo-graphitic carbon-based materials, lamellar minerals as defined previously, metal chalcogenides of lamellar structure, of general formula MaXb, in which M represents a metal and X a chalcogen, a and b representing the respective proportions of metal and of chalcogen, such as WS₂, MoS₂, MoSe₂, MoTe₂, WSe₂ or GaSe, GaTe. These materials have a hexagonal and lamellar structure, i.e. they consist of crystallographic planes of semiconductive MX₂ leaflets linked via van der Waals interactions. An MX₂ leaflet consists of a plane of atoms of a metal (M) sandwiched between two planes of chalcogen atoms (X). Within the leaflets, the atomic bonds between M and X are covalent and thus solid. On the other hand, the leaflets are connected together via weak atomic interactions (van der Waals forces between the chalcogen planes), thus allowing easy sliding perpendicular to the leaflets, which is the origin of their lubricant capacity in the solid state. For the purposes of the present invention, the laminar materials also comprise semi-metals (for example WTa₂. TcS₂), superconductors (for example NbS₂, TaSe₂), or topological insulators and thermoelectric materials (for example Bi₂Se₃, Bi₂Te₃).

For the purposes of the present invention, the term “graphitic material” denotes a crystalline laminar material consisting of a stack of leaflets of hexagonal structure, in which the leaflets are connected together via weak atomic interactions (van der Waals forces), thus allowing easy sliding perpendicular to the direction of the stack of leaflets, like graphite.

For the purposes of the present invention, the term “pseudo-graphitic carbon-based material” denotes a crystalline material characterized by the regular arrangement of tetrahedra of a metal (for example silicon) and of carbon, like graphite and diamond. Silicon carbide is among these pseudo-graphitic carbon-based materials. Specifically, the structure of silicon carbide is marked, like for graphite and diamond, by the regular arrangement of silicon and carbon tetrahedra which can become arranged in a cubic structure of ZnS type: β-SiC, but also in hexagonal or rhombohedric structures: α-SiC which is the usual structure of high temperatures, but the β-SiC structure may be stabilized with small amounts of impurities. There exists, moreover, a method for synthesizing graphene from SiC by thermal decomposition of SiC (Si sublimes and C becomes graphitized).

For the purposes of the present invention, the term “nanomaterial” denotes a material whose size is a few nanometers in at least one of the spatial dimensions. For example, the size of the material in at least one of the spatial dimensions is between 1 and 100 nm, preferably between 1 and 50 nm, preferably between 1 and nm, preferably between 1 and 5 nm.

For the purposes of the present invention, the term “nanocarbon” denotes any nanometric-sized carbon-based ordered structure. The term “nanometric-sized carbon-based structure” means a carbon-based material whose size is approximately between the thickness of a graphene plane to a few nanometers in at least one of the spatial dimensions. For example, the size of the carbon-based material in at least one of thespatial dimensions may be between 0.3 and 100 nm, preferably between 0.3 and 50 nm, preferably between 0.3 and 20 nm, preferably between 0.3 and 10 nm, more preferentially between 0.3 and 2 nm. Nanocarbons comprise carbon nanofibers, nanodiamonds and carbon nanohoms. Other forms of ordered carbon such as hydrogenated or partially hydrogenated forms of the abovementioned nanocarbons such as partially hydrogenated graphene (for example graphyne, graphane), and also materials of fullerene type, carbon nanotubes (single-walled (SWCNT), double-walled (DWCNT), few-walled (FWCNT) and multi-walled (MWCNT)), cup-stacked nanocarbons, carbon nanocones, etc., or any hydrogenated or partially hydrogenated form thereof, are also covered by the term “nanocarbon”. Nanocarbons comprise i) nanocarbon-based compounds having a definable unique structure (for example individual carbon nanofibers, the exfoliated graphene planes of graphite, or individual units of carbon nanohorns, or of nanodiamonds); or ii) aggregates of nanocarbon-based structures (for example raw carbon nanofibers, stacked graphene planes (namely graphite or turbostratic carbon), raw nanodiamonds, or raw carbon nanohoms.

For the purposes of the present invention, the term “dispersed” refers to a composition in which the material under consideration is in suspension (or dispersed) in a solvent. In other words, the dispersion contains solid particles of material in suspension/dispersion in the solvent. In general, in the context of the present invention, the term “dispersed nanomaterial” covers completely individualized nanomaterials (for example mono-leaflet graphene), and also partially disintegrated nanomaterials such as multi-leaflet graphene, or chopped carbon nanofibers. When the nanomaterial under consideration is laminar, for example a graphitic material, it may be exfoliated in addition to being dispersed. In the context of the present invention, the dispersion is furthermore stabilized by the natural polymolecular system used to implement the dispersion/exfoliation process according to the invention.

For the purposes of the present invention, the term “polar solvent” refers to any organic or aqueous solvent whose dielectric constant is ≥4. In particular, it may be a polar protic solvent.

As mentioned previously, the process according to the invention leads to the formation of a nanocomposite consisting of the exfoliated and/or dispersed laminar material, the size of which in at least one of the spatial dimensions may be between 1 and 100 nm, and the natural polymolecular system, preferably in the form of a colloid. Thus, the present invention also relates to a nanomaterial/natural polymolecular system nanocomposite in which the nanomaterial may be an exfoliated and/or dispersed laminar material, the size of which in at least one of the spatial dimensions may be between 1 and 100 nm, and the polymolecular system has a hydrophilic/lipophilic balance (HLB)≥8 and may be chosen from phosphoglycerides, omega-3 fatty acids, plant extracts (preferably aqueous or aqueous-alcoholic extracts), or biopolymers selected from proteins, polysaccharides or natural gums.

Preferably, when the nanomaterial is graphene (mono-leaflet or multi-leaflet), the natural polymolecular system is not a gum arabic, a guar gum, a locust bean gum, a carrageenan, a xanthan gum, or a combination thereof, in particular when the process is performed to form a colloid with a concentration of monolayer or multilayer graphene ≤0.5 to 1 g/L as nanocomposite.

Exfoliated and/or Dispersed Laminar Nanomaterial

Advantageously, the exfoliated and/or dispersed laminar nanomaterial may be chosen from nanocarbons, nitrogen-based nanomaterials, lamellar inorganic nanomaterials, silicon-based pseudo-graphitic nanomaterials, or laminar minerals.

Advantageously, it may be:
an exfoliated and/or dispersed nanocarbon, for example graphitic, such as graphene, multi-leaflet graphene, carbon nanofibers, nanodiamonds or nanohoms;
a dispersed nitrogen-based nanomaterial such as carbon nitride or boron nitride;
an exfoliated and/or dispersed lamellar inorganic nanomaterial of the family of metal chalcogenides such as WS₂, MoS₂, WSe₂ or GaSe, of semi-metals (for example WTa₂, TcS₂), of superconductors (for example NbS₂, TaSe₂), or else of topological insulators and thermoelectric materials (for example Bi₂Se₃, Bi₂Te);
a silicon-based dispersed pseudo-graphitic nanomaterial such as silicon carbide; or
a dispersed lamellar/laminar mineral such as:
   clay, potter's clay, gypsum, muscovite, calcite, galene, halite;
   the family of “laminar oxides” in general, for example V₂O₅, MoO₃, MnO₂, LaNb₂O₇, TiO₂;
   lamellar phyllosilicates, such as talc (Mg₃Si₄O₁₀ (OH)₂), micas and montmorillonite;
   lamellar oxides of general formula AxMO₂, in which A=alkali metal ion, M=transition metal element and x is between 0.5 and 1 (such as NaxMO₂, NaxVO₂, LiCoO₂);
   lamellar perovskite oxides, for instance M[La₂Ti₃O₁₀] in which M=Co, Cu, Zn;
   “lamellar double hydroxides” (or “LDH”) (for example MgeAl₂(OH)₁₆); or
   lamellar metal halides (for example Cdl₂, MgBr₂).

As regards the nanocomposite according to the invention, the natural polymolecular system constituting it may be as defined previously for the exfoliation and/or dispersion process according to the invention, namely a protein such as hemoglobin, myoglobin or bovine serum albumin; a polysaccharide such as maltodextrin, pectins such as pectin E 440, alginates, or gelatin; lecithin, casein, chitin; a natural source of omega-3 fatty acid such as a fish liver oil; a plant extract such as an extract of okra or an extract of the ground fruit and leaves of African baobab (preferably aqueous or aqueous-alcoholic extracts); or a gum such as gum tragacanth, karaya gum, tara gum, gellan gum, konjac gum or agar-agar.

Advantageously, as regards the nanocomposite according to the invention, the natural polymolecular system constituting it may be as defined previously for the exfoliation and/or dispersion process according to the invention and may be nonionic, namely a protein such as hemoglobin, myoglobin, bovine serum albumin, a polysaccharide such as maltodextrin, agar-agar or a plant extract such as an extract of okra or of the ground fruit and leaves of African baobab.

Advantageously, the exfoliated and/or dispersed laminar nanomaterial may be an exfoliated and/or dispersed nanocarbon, for example graphitic, such as graphene, multi-leaflet graphene, carbon nanofibers, nanodiamonds or nanohoms or an exfoliated and/or dispersed lamellar inorganic nanomaterial of the family of metal chalcogenides such as WS₂, MoS₂, WSe₂ or GaSe, of semi-metals (for example WTa₂, TcS₂), of superconductors (for example NbS₂, TaSe₂), or of topological insulators and thermoelectric materials (for example Bi₂Se₃, Bi₂Te), and the natural polymolecular system constituting it may be nonionic, namely a protein such as hemoglobin, myoglobin, bovine serum albumin, a polysaccharide such as maltodextrin, agar-agar or a plant extract such as an extract of ocra or of the ground fruit and leaves of African baobab.

According to another aspect, the invention relates to a colloid of nanomaterial/natural polymolecular system nanocomposite in a polar solvent, in which the concentration of exfoliated/dispersed nanomaterial in the polar solvent may be ≥1 g/L, preferably ≥2 g/L, more preferentially ≥3 g/L, or even more preferentially ≥4 g/L. or even ≥5 g/L, and in which the nanomaterial may be an exfoliated and/or dispersed laminar material and the natural polymolecular system has a hydrophilic/lipophilic balance ≥8 and may be chosen from phosphoglycerides, omega-3 fatty acids, plant extracts (preferably aqueous or aqueous-alcoholic extracts), or biopolymers selected from proteins, polysaccharides or natural gums.

Advantageously, the concentration of exfoliated/dispersed nanomaterial in the polar solvent may be ≥1 g/L, preferably ≥2 g/L, more preferentially ≥3 g/L, even more preferentially ≥4 g/L, or even ≥5 g/L. The concentration may be ≥7 g/L, or even ≥10 g/L or else even ≥20 g/L.

As regards the colloid according to the invention, the nanomaterial and the natural polymolecular system are as defined previously for the nanocomposite according to the invention. Preferably, the natural polymolecular system may be hemoglobin, myoglobin, bovine serum albumin, maltodextrin, agar-agar or an extract (preferably an aqueous or aqueous-alcoholic extract) of okra or of the ground fruit and leaves of African baobab.

As regards the colloid according to the invention, the polar solvent may be as defined previously for the exfoliation and/or dispersion process, namely H₂O, a C1 to C8 and preferably C2 to C4 alcohol, or a mixture thereof: preferably H₂O, i-PrOH, or a mixture thereof; preferably H₂O.

Advantageously, the colloid according to the invention may be in emulsion, gel, suspension, paste or solution form. The term “solution” will be used in the case of natural polymolecular systems with a very high hydrophilic/lipophilic balance (typically >12) and exfoliated/dispersed nanomaterials of small size (a few nanometers) and low concentration (<5 g/L) as exfoliated/dispersed nanomaterial in the colloid obtained.

According to another aspect, the invention relates to the use of a nanocomposite or nanocomposite colloid according to the invention for the manufacture of conductive inks, of conductive coatings such as conductive paints, of catalysts such as metal-free catalysts for the selective dehydrogenation of ethylbenzene or styrene, or of energy storage systems. The nanocomposite or nanocomposite colloid according to the invention may also be used as additive in polymers and composites for modifying the electrical, mechanical, thermal or barrier (for example with respect to oxygen, moisture or gases) properties, in cement, as catalytic support, in the manufacture of electrodes and conductive layers, in the manufacture of transparent electrodes and layers for facilitating charge transport in devices of the type such as: photovoltaic devices, liquid crystals, light-emitting diodes, touchscreens and “smart windows” in general, in the manufacture of conductive films, in the production of layers for mechanical reinforcement, in tribology (this term covers, inter alia, all the fields of friction, wear, the study of interfaces and lubrication), for the formation of conductive networks, for example by self-assembly, i.e. assembly in an electric/magnetic field, in biomedical applications (for example prostheses, sensors, drug vectors), or in membranes/filters, or in applications in batteries, supercapacitors, and applications in magnetism. In general, any use in which the properties of the exfoliated and/or dispersed nanomaterial may be of interest may be envisaged in the context of the present invention.

By way of example, the exfoliation and/or dispersion process according to the invention, applied to carbon nanofibers of “fishbone” type, makes it possible to obtain carbon-based structures which have proven to be highly efficient as catalysts, for example in the dehydrogenation reaction of ethylbenzene to styrene.

### Advantages

The present invention offers many advantages, in particular
the production of nanocomposite colloids with a very high concentration of exfoliated/dispersed nanomaterial (for example in the form of gels, suspensions or emulsions, which may find an application, for example, in conductive inks, paints and pastes), or in the form of a solution with high stability, and this being possible without the need for a step of concentrating the colloid, for example by evaporation of the polar solvent. In particular, the process according to the invention makes it possible to obtain colloids of nanomaterial/natural polymolecular system nanocomposite in a polar solvent, in which the concentration of exfoliated/dispersed nanomaterial in the polar solvent may be ≥1 g/L, preferably ≥2 g/L, more preferentially ≥3 g/L, even more preferentially ≥4 g/L, or even ≥5 g/L, or else even ≥7 g/L without a subsequent step of concentration of the colloid. Needless to say, this concentration of exfoliated/dispersed nanomaterial in the colloid may be increased by subjecting the colloid to a concentration step (for example by evaporation of the polar solvent). However, the major advantage of the process relative to other known methods is the possibility of directly obtaining colloids with a concentration ≥1 g/L, preferably ≥2 g/L, more preferentially ≥3 g/L, even more preferentially ≥4 g/L, or even ≥5 g/L, or else even ≥7 g/L, without the need for a concentration step. For example, nanocomposite colloids with a very high concentration of exfoliated/dispersed nanomaterial may be obtained when the laminar carbon-based material is graphite and the natural polymolecular system is nonionic and when they are subjected to the action of the source of shear forces coupled with mechanical stirring, or alternatively when the laminar carbon-based material is expanded graphite and the natural polymolecular system is nonionic, the action of the source of shear forces possibly being coupled with mechanical stirring.
the yields of exfoliated and/or dispersed nanomaterial obtained via the process according to the invention are significantly higher than those that may be expected with other existing methods. On average, yields of from 60% to 80%, or even up to 100%, may be obtained according to the process of the invention.
the concentrations (several grams per liter) of exfoliated and/or dispersed nanomaterial obtained via the process according to the invention are also very much higher than those obtained with other existing methods. These high concentrations especially allow the production of graphene (monolayer or multilayer) in large amount at a very low cost.
in addition, the process according to the invention is based on an implementation in an aqueous solvent, or even water, and, in this respect, is environmentally friendly, economical and industrially attractive.

Other advantages may also appear to a person skilled in the art on reading the examples below, with reference to the attached figures, which are given as nonlimiting illustrations.

### EQUIVALENTS

The representative examples which follow are intended to illustrate the invention and are not intended to limit the scope of the invention, and should not be interpreted as such. Specifically, various variants of the invention and many other embodiments thereof, and also advantages other than those described in the present document, will become apparent to a person skilled in the art from the content of this document as a whole, including the examples that follow.

The examples that follow contain important additional information for illustration and teaching which may be adapted to the implementation of this invention in its various embodiments and the equivalents thereof.

### BRIEF DESCRIPTION OF THE FIGURES

FIG. 1: Photographs representing A) a suspension of expanded graphite (EG) in water, B) a suspension of expanded graphite (EG) water in the presence of hemoglobin (HEM) before exfoliation/dispersion according to the process of the invention, C) an FLG-water-HEM (multilayer graphene/water/hemoglobin) colloid according to the invention.

FIG. 2: SEM micrographs of multilayer graphene/HEM nanocomposite obtained after exfoliation of EG in water in the presence of HEM for 2 hours of ultrasonication and 2 days of decantation, A,B) representing the fraction in the supernatant (FLG-HEM) and C,D) representing the decanted part with a majority of the hemoglobin residues.

FIG. 3: TEM micrographs of multilayer graphene colloid obtained in the supernatant, after exfoliation of EG in water in the presence of HEM for 2 hours and 2 days of decantation. Image B shows the cleavage of FLG. The number of layers in the product may clearly be counted in images C and D.

FIG. 4: A) Raman spectra of FLG-HEM nanocomposite showing a high degree of graphitization (peak D, and the very low ratio of peaks D/G) and a varied number of layers (up to 5 layers). B) UV-vis spectra of the aqueous solution of HEM and of the suspension of FLG-HEM in water before and after ultrasonication.

FIG. 5: A) Representative I(V) curves obtained via the four-point method on a “paper” of FLG-HEM and FLG-HEM-700° C., B and C) SEM micrographs of the paper showing its thickness and its surface.

FIG. 6: A, B) SEM micrographs and C,D) TEM micrographs of multilayer graphene obtained by exfoliation and dispersion of EG in water in the presence of HEM for 5 hours of ultrasonication and 2 days of decantation (supernatant part).

FIG. 7: A) TGA derivatives of EG, FLG-HEM and of FLG-HEM-5h showing that the combustion temperature decreases gradually after a prolonged ultrasonic treatment, B) XPS spectra of EG, FLG-HEM and FLG-HEM-5h.

FIG. 8: SEM and TEM micrographs of multilayer graphene nanocomposite obtained by exfoliation of EG in water in the presence of BSA (FLG-BSA nanocomposite) for 2 hours of ultrasonication and 2 days of decantation (supernatant part).

FIG. 9: A) Representative I(V) curves obtained via the four-point method on “papers” of FLG-BSA and FLG-acid (treated by hydrolysis), B and C) SEM micrographs of these “papers” showing their thicknesses.

FIG. 10: TGA derivatives of FLG-acid and FLG-acid-700° C. showing an increase in the combustion temperature for the sample treated at high temperature under helium.

FIG. 11: Photograph of FLG-BSA colloid (with a ratio of 10:1) in water with a concentration of A) of 40 g/L, B) of 0.04 g/L (i.e. diluted 1000-fold).

FIG. 12: Photograph of FLG-BSA colloid (with a ratio of 10:1) in water: A) 40 g/L, B) 4.0 g/L, C) 0.4 g/L, D) 0.04 g/L with formation of aggregates, E) 0.04 g/L with an FLG-BSA ratio of 10:2, or amount of BSA was added to D) and sonicated for 10 min.

FIG. 13: Optical image of FLG-BSA colloid obtained in the ultrasonic bath.

FIG. 14: A) Photograph of FLG-BSA colloid with a concentration of 11.3 g/L, B) corresponding SEM micrograph.

FIG. 15: Optical image of aqueous colloids of (from left to right) boron nitride, carbon nitride, nanodiamonds, silicon carbide, carbon nanofibers obtained after ultrasonication for 2 hours in the presence of BSA.

FIG. 16: A) SEM micrograph and B) TEM micrograph of starting carbon nanofibers (CNF).

FIG. 17: TEM micrographs of colloid of carbon nanofibers in water obtained by ultrasonication in the presence of HEM for 1 hour (CNF-HEM nanocomposite colloid).

FIG. 18: A) TGA derivatives of the starting carbon nanofibers (CNF) and of the CNF-HEM nanocomposite obtained according to the process of the invention, B) temperature-programmed desorption of the starting CNFs and of the CNF-HEM nanocomposite.

FIG. 19: The results of the catalytic tests (conversion and selectivity in the dehydrogenation reaction of ethylbenzene to styrene, as a function of the flow time) obtained on two catalysts: initial carbon nanofibers (CNF) and the product obtained after exfoliation of CNF in water in the presence of HEM according to the process of the invention (CNF-HEM nanocomposite).

FIG. 20: Comparison of the catalytic performance of a catalyst obtained via the process according to the invention (CNF-HEM nanocomposite) with the starting material (CNF), a commercial catalyst (K—Fe) and a carbon-based catalyst, which is the most active known to date in the literature.

FIG. 21: TEM micrographs of the FLG-CNF-HEM composite obtained according to the process of the invention after ultrasound treatment of EG and CNF in water in the presence of HEM (FLG-CNF-HEM nanocomposite).

FIG. 22: TEM micrographs of FLG-maltodextrin nanocomposite according to the invention and photograph of this colloid in water and in isopropanol.

FIG. 23: (A. B) Images illustrating the flexibility and the electrical conductivity of FLG/fabric obtained by exfoliation of expanded graphite in the presence of maltodextrin according to the invention, for applications as smart textiles. (B, C) Image of the FLG/polyurethane foam composite demonstrating the variation of the electrical conductivity as a function of the pressure for their uses as sensors.

FIG. 24: SEM micrographs of: A and B) graphite, the starting material, B and C) the heavy part (bottom) of the colloid after exfoliation of graphite in water+HEM for hours, decanted for 24 hours.

FIG. 25: SEM micrographs of the products found in the supernatant separated out after the process of exfoliation of graphite in water in the presence of HEM for hours, and 24 hours of decantation, A and B) second fraction (heavier), C and D) first fraction (light).

FIG. 26: TEM micrographs of multilayer graphene obtained after exfoliation of EG by ultrasound treatment in water in the presence of agar-agar.

FIG. 27: Images illustrating (A) Dispersion of C₃N₄ in the absence and in the presence of maltodextrin after the ultrasonication process and leaving to stand for 1 day. (B) Dispersion of C₃N₄ in the absence and in the presence of maltodextrin 15 days later.

### EXAMPLES

### Abbreviations

CNF: carbon nanofibers
EG: expanded graphite
FLG: multilayer graphene
Aa: agar-agar
BSA: bovine serum albumin
HEM: hemoglobin
SEM: scanning electron microscopy
TEM: transmission electron microscopy

Starting Materials

The bovine blood hemoglobin and bovine serum albumin were purchased from Sigma-Aldrich. The expanded graphite (EG) was purchased from the company Carbone Lorraine. The graphite pellets were purchased from the company Timcal. The boron nitride was purchased from the company Johnson Matthey Company. The nanodiamonds were purchased from Carbodeon Co. Ltd. The silicon carbide was purchased from SICAT SARL. The carbon nanofibers were prepared by catalytic chemical vapor deposition (CCVD).

Catalytic Tests

The conditions used for the catalytic test, the analysis and the conversion of the products, and the selectivity calculations are the same as those reported previously [11]. Briefly, a dehydrogenation without steam of ethylbenzene to styrene was performed with 300 mg of catalyst (CNF-HEM or CNF), at an ethylbenzene flow rate (2.8% in He) of 30 ml/min at 550° C. at atmospheric pressure. The reagents and the products were analyzed online by gas chromatography (Perichrom, PR 2100) with flame ionization detection (FID).

Characterization

Scanning electron microscopy (SEM): the microscopy was performed on a Jeol 2600F instrument operating at an acceleration voltage of 15 kV and an emission current of 10 mA.

The transmission electron microscopy (TEM) images were acquired on a Jeol 2100F machine at an acceleration voltage of 200 kV, equipped with a probe corrector for spherical aberrations, and a point-to-point resolution of 0.2 nm. Before the analysis, drops of aqueous suspensions were deposited on a film a grate covered with a carbon membrane.

The X-ray photoelectron spectroscopy (XPS) measurements were taken in a UHT installation (base pressure 1×10⁻⁹ mbar) equipped with a WA hemispherical electronic analyzer of VSW category (150 mm in radius) with a multi-channeltron detector. A monochromatic X-ray source (Al Kα anode operating at 240 W) was used as incident beam. The XP spectra were recorded in fixed transmission mode using pass energies of 90 for the survey scans and 44 eV for the narrow scans. The Shirley method was used for subtraction of the baseline, before the adjustment procedure.

The Raman spectra were recorded using LabRAM ARAMS Horiba Raman spectrometry equipment in a 500-4000 cm⁻¹ range at a laser excitation wavelength of 532 nm. Before the measurements, the samples were deposited on an SiO₂/Si substrate by impregnation using a Pasteur pipette and then dried thoroughly.

The UV-Vis spectra of the dispersions were recorded on a spectrophotometer equipped with a PTP1 Peltier effect system (PerkinElmer Lambda 35) at room temperature.

Layer Resistance

The layer resistance (Rs) measurements were taken on thin paper by the four-point probe (FPP) method, by inducing a different current (I); from 1 pA to 1 mA using two external probes and by measuring the voltage difference (V) between two internal probes, with a Keithley 220 programmable current source coupled to a Hewlett-Packard 34401A multimeter. In the calculation of the Rs values from Ohm's law, a geometrical factor of the samples was considered [12].

General Protocol for Exfoliation and/or Dispersion of Laminar Materials

x mg of starting laminar material and y mg of natural polymolecular system of HLB ≥8 are added to z ml of distilled water with the ratio x:y:z varied. The ultrasound treatment may or may not be assisted with mechanical stirring, and the duration is between 5 minutes and 50 hours. The ultrasonication power and the mixture volume may be varied. The colloids obtained contain exfoliated/dispersed nanomaterials in the form of nanocomposites with the molecules of the natural polymolecular system. For the purpose of obtaining stable dispersions and/or exfoliated/dispersed nanomaterials, the dispersions are left to stand (1 hour-few days) in order to decant the heavy parts and/or are centrifuged. The supernatants thus obtained are stable for long periods (days-months).

The concentrations and yields of exfoliated and/or dispersed nanomaterial are calculated from the amount of the heavy parts decanted. The colloid obtained is thus separated from the heavy parts, which are dried and weighed. The yields and the concentrations are calculated on the basis of the mass of exfoliated and/or dispersed nanomaterials remaining stable in the colloid.

### Example 1—FLG-HEM Nanocomposite

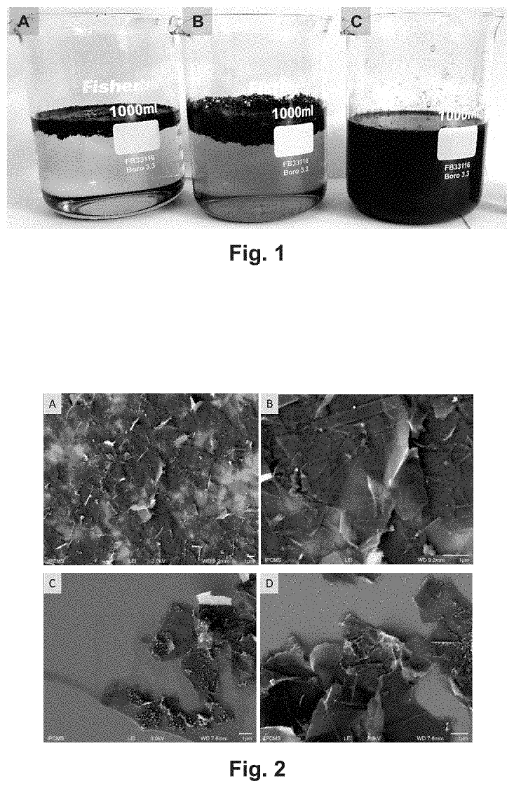

300 mg of expanded graphite (EG) and 30 mg of hemoglobin (HEM) are added to 300 ml of distilled water in a 1000 ml beaker. The mixture is subjected to an ultrasound treatment using a Branson Digital Sonifier 450 ultrasonic finger at a frequency of ˜50/60 Hz with a power of 10% of 400 W. and assisted with mechanical stirring for 2 hours (FIG. 1).

The mixture obtained is left to decant for 2 hours. The 250 ml of supernatant containing the exfoliated multilayer graphene (in FLG-HEM nanocomposite form) and a remaining portion of the hemoglobin are then separated from the bottom. The exfoliation yield calculated as a function of the mass of multilayer graphene obtained in the supernatant relative to the initial mass of expanded graphite is 60%. The SEM images of multilayer graphene obtained in the supernatant are presented in FIG. 2 A, B. The SEM images of the decanted part (bottom) containing the majority of the graphite and hemoglobin residues with a lower degree of exfoliation (sheets with higher numbers of layers) are shown in FIG. 2 C, D.

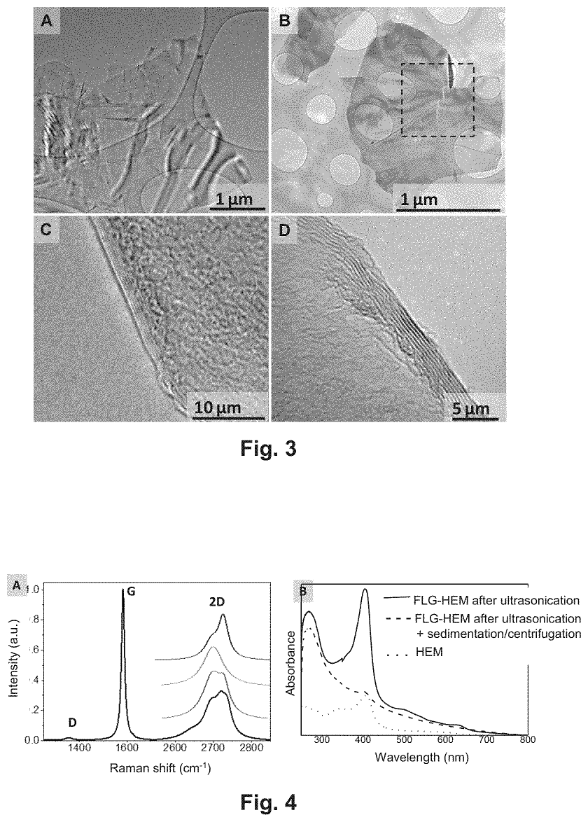

The number of layers is varied and relatively small (≤10) in the multilayer graphene obtained (FIG. 3) and these observations were confirmed by the Raman spectroscopy performed on several FLGs (peak 2D) (FIG. 4 A). The full spectrum also reveals the high quality of FLG obtained, with a very low defect content (peak D and the ratio of peak D and G is very small).

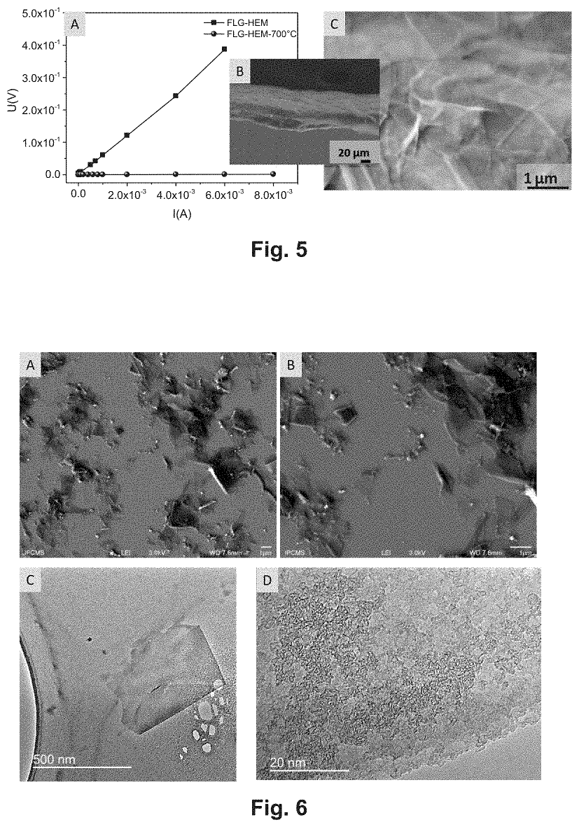

The dispersion obtained is filtered in the form of blotting paper and dried at 130° C., and the electrical resistance of the material obtained is measured by the four-point probe method. The electrical conductivity is then calculated on the basis of the resistance obtained (adjusted by the geometrical factor) and the 50 μm mean thickness of the “paper” is determined by SEM imaging. The paper is also subjected to a high-temperature treatment of 700° C. under helium and its electrical conductivity was measured. The conductivity of the starting material is of the order of 10² S/m and rises to 10⁴ S/m after the treatment at 700° C. FIG. 5 shows I(V) curves and the associated SEM images.

### Example 2—FLG-HEM-5h Nanocomposite

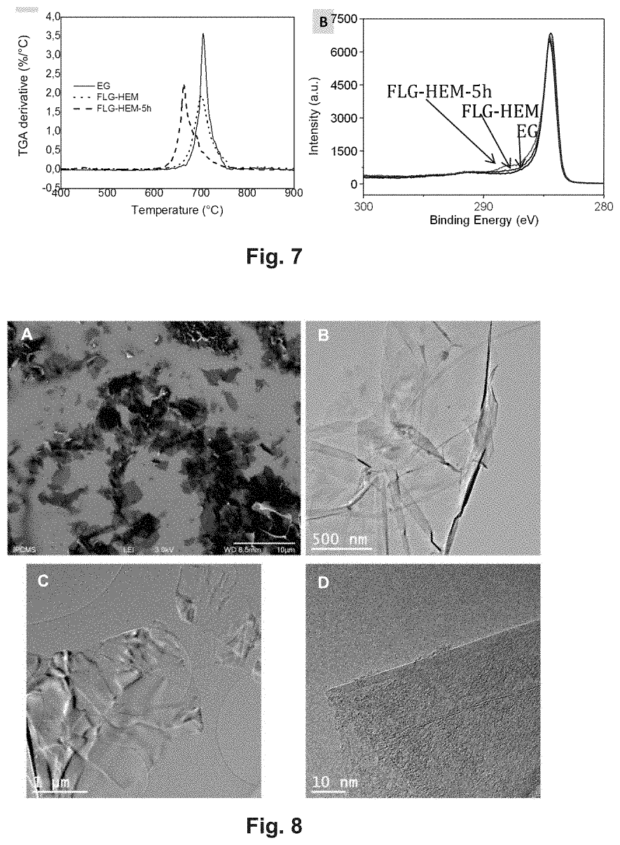

300 mg of expanded graphite (EG) and 30 mg of hemoglobin (HEM) are added to 300 ml of distilled water in a 1000 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 5 hours (FIG. 1). The mixture obtained is left to decant for 2 days. The 250 ml of supernatant containing the multilayer graphene (in FLG-HEM nanocomposite form) and a remaining portion of the hemoglobin are then separated from the bottom. SEM, TEM. XPS and TGA analysis confirms that the multilayer graphene obtained in the supernatant shows smaller sheet sizes (more chopped) and contains more structural defects with a higher oxygen content: FIG. 6 and FIG. 7. The TGA analysis shows that the combustion temperature decreases gradually after prolonged ultrasonication treatment (FIG. 7A). The XPS analysis confirms that the oxygen content for EG, FLG-HEM and FLG-HEM-5h increases gradually, the O/C ratio calculated by the respective O1s/C1s ratio is 0.024, 0.039 and 0.090, and the full width at half-maximum of peak Cis also increases successively with a prolonged ultrasonication treatment: 1.18, 1.21, 1.25.

### Example 3—FLG-BSA Nanocomposite

300 mg of expanded graphite (EG) and 30 mg of bovine serum albumin (BSA) are added to 300 ml of distilled water in a 1000 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 2 hours. The mixture obtained is left to decant for 2 days. The 250 ml of supernatant containing the multilayer graphene (in FLG-BSA nanocomposite form) and a remaining portion of the albumin are then separated from the bottom. The exfoliation yield calculated as a function of the mass of multilayer graphene obtained in the supernatant relative to the initial mass of expanded graphite is 70%, and the SEM and TEM images of the multilayer graphene obtained in the supernatant are presented in FIG. 8.
a) The dispersion obtained is filtered in the form of blotting paper and dried at 130° C. and the electrical resistance of the material obtained is measured by the four-point probe method. The electrical conductivity is then calculated on the basis of the resistance obtained (adjusted by the geometrical factor) and the 30 μm mean thickness of the “paper” is determined by SEM imaging. The conductivity of the material is of the order of 10² S/m. FIGS. 9 A and B show the associated I(V) curve and SEM image. It should be noted that filtration of the FLG-BSA nanocomposite gives a structure in sponge form. This is due to the presence of BSA, which has detergent properties (FIG. 9B). The FLG-BSA “paper” was subjected to a high-temperature treatment (700° C. under helium) for 2 hours and its conductivity went from 10² S/m to 10⁴ S/m.
b) The dispersion obtained is dried and the product is subjected to the hydrolysis treatment in refluxing aqua regia for 2 hours. The product is then filtered off and washed to neutral pH and dried at 130° C. for 2 hours, and is then redispersed in isopropanol and filtered off to form a “paper”. The “paper” obtained is dried for 20 hours at 50° C. and its electrical resistance is measured via the four-point probe method. The electrical conductivity calculated for a thickness of 0.4 μm is of the order of 10⁵ S/m. FIGS. 9A and C show the associated I(V) curve and SEM image. The increase in conductivity after treatment at high temperature is linked to the desorption of oxygenated groups and other possible impurities.

The FLG-acid “paper” is also treated at high temperature (700° C., 2 hours).

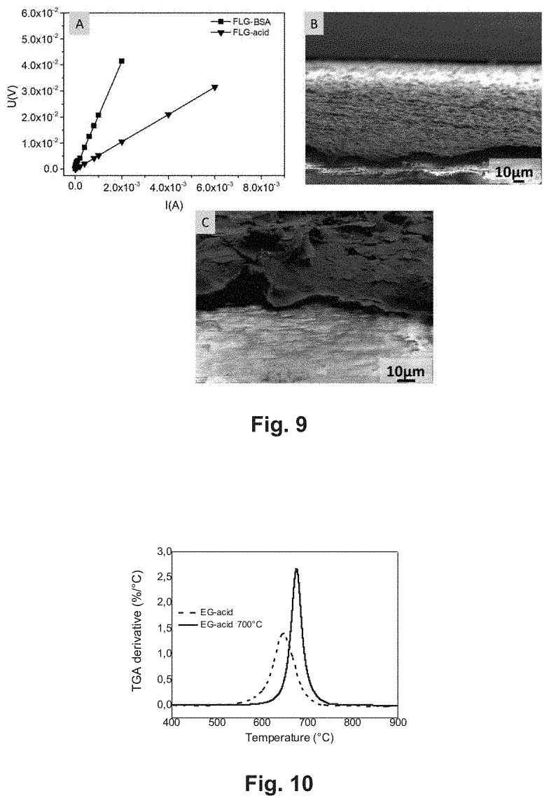

The TGA derivatives of the FLG-acid and FLG-acid-700° C. samples reveal a higher combustion temperature for the sample treated at high temperature (FIG. 10). The XPS analysis is in agreement with these data and gives a ratio of O to C which decreases, going from 0.035 to 0.025.

### Example 4—FLG-BSA Nanocomposite Ink

2.5 g of expanded graphite (EG) and 250 mg of bovine serum albumin (BSA) are added to 500 ml of distilled water in a 1000 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 2 hours. The dispersion is left to stand for 24 hours and the resulting colloid (supernatant) has a multilayer/monolayer graphene concentration of 6.3 g/L and may be used as conductive ink or paint. The exfoliation yield calculated as a function of the mass of multilayer/monolayer graphene obtained in the supernatant relative to the initial mass of expanded graphite is 63%.

### Example 5—FLG-BSA Nanocomposite Foam and Paste

12.8 g of expanded graphite (EG) and 1.28 g of bovine serum albumin (BSA) are added to 320 ml of distilled water in a 1000 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 2 hours.

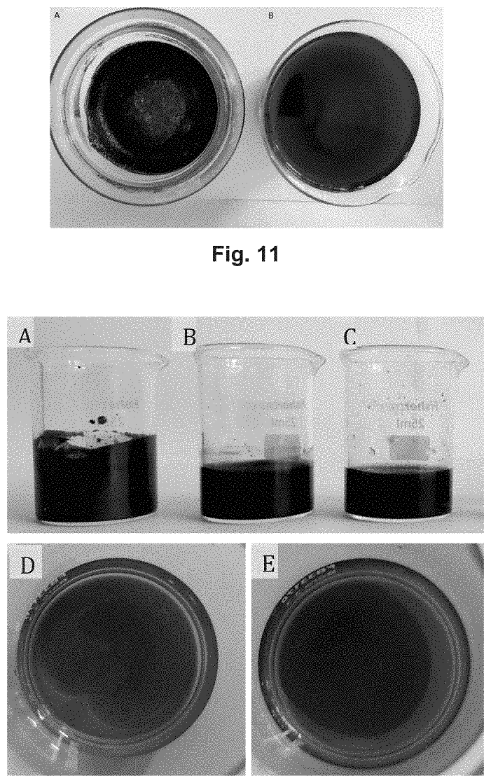

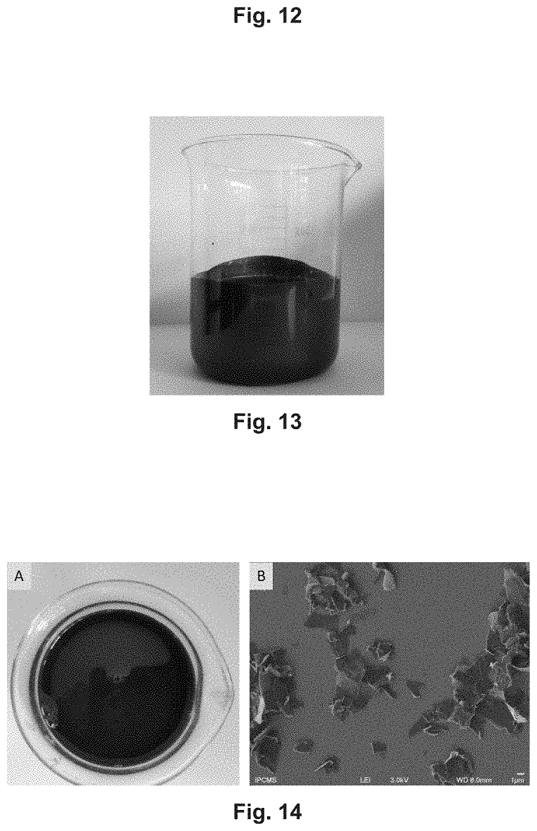

FIG. 11 A shows the resulting colloid with a foam aspect linked to the detergent function of BSA. FIG. 11 B shows this colloid diluted 1000-fold. The dispersion remains very stable (FIG. 12A: 40 g/L, B) 4 g/L, C) 0.4 g/L). At 1000-fold dissolution (0.04 g/L), the formation of slight aggregates may be seen (FIG. 12D), which may be redispersed by short sonication (10 minutes), adding a very small amount of BSA.

4.5 g of EG and 0.45 g of BSA were added to the FLG-BSA colloid with a multilayer/monolayer graphene concentration of 40 g/L. The resulting mixture is then subjected to sonication assisted with stirring for 1 hour. The final colloid has a multilayer/monolayer graphene concentration of 54 g/L. After 24 hours, the stable final colloid (supernatant) is recovered and has a multilayer/monolayer graphene concentration of 46 g/L for an exfoliation yield of 85%. Additional drying for 24 hours gives a paste with a multilayer/monolayer graphene concentration of 80 g/L.

### Example 6—FLG-BSA Nanocomposite

10 g of expanded graphite (EG) and 1 g of bovine serum albumin (BSA) are added to 800 ml of distilled water in a 1000 ml beaker. The mixture is subjected to an ultrasound treatment using a Bransonic ultrasonic bath at a frequency of ˜50/60 Hz with a power of 10% of 400 W, and assisted with mechanical stirring for 15 hours. An amount of water is added from time to time to make up for the water evaporated. The colloid (FLG-BSA) with a very high concentration of multilayer/monolayer graphene is obtained (FIG. 13).

### Example 7—FLG-BSA Nanocomposite

7.5 g of glittery graphite and 0.75 g of bovine serum albumin (BSA) are added to 250 ml of distilled water in a 1000 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 3 hours. The resulting colloid is left to stand for 24 hours. Next, the decanted part and the 200 ml stable part (supernatant) are separated. The yield for this exfoliation calculated on the basis of the stable part is 30% for a concentration of multilayer/monolayer graphene of 11.3 g/L (FIG. 14).

### Example 8—HEM Nanocomposites

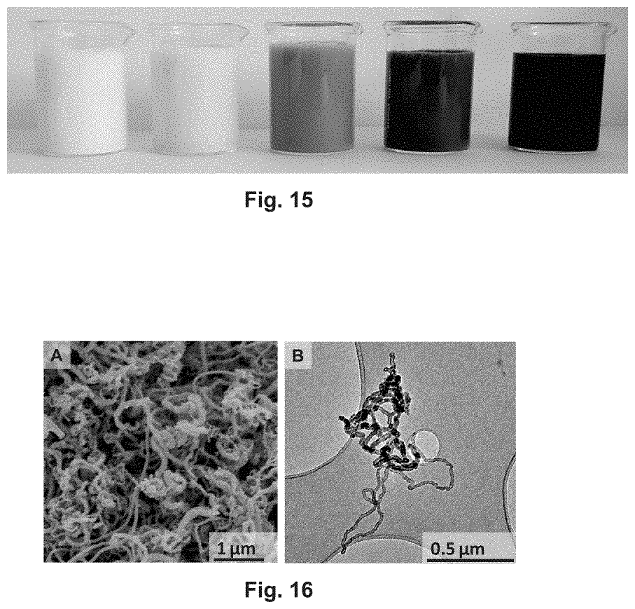

2 g of different laminar/lamellar materials (chosen from boron nitride, carbon nitride, nanodiamonds, silicon carbide, carbon nanofibers) and 0.2 g of BSA are placed in 250 ml of distilled water in a 600 ml beaker. Each mixture is subjected to an ultrasound treatment using a Branson Digital Sonifier 450 ultrasonic finger at a frequency of ˜50/60 Hz with a power of 10% of 400 W, and assisted with mechanical stirring for 2 hours. The colloids obtained are left to stand for 24 hours and photographs of these samples were collected (FIG. 15).

### Example 9—CNF-HEM Nanocomposite

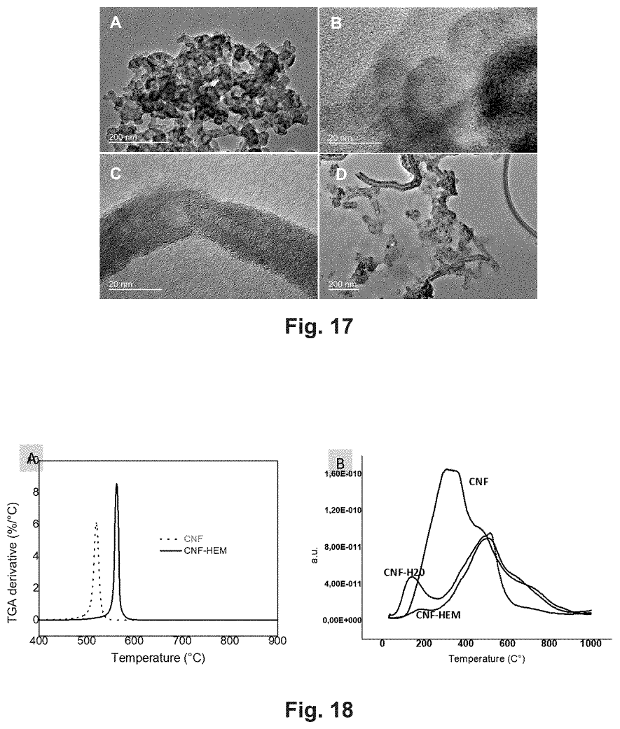

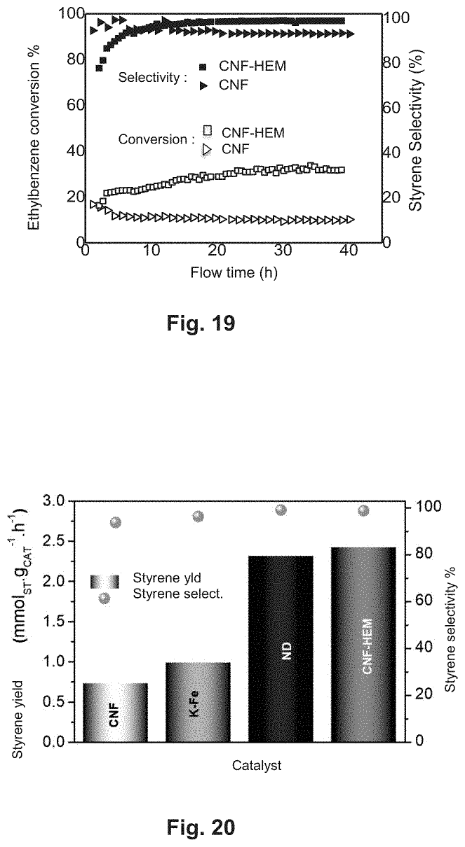

300 mg of carbon nanofibers (CNF) (FIG. 16) and 30 mg of HEM are added to 300 ml of distilled water in a 1000 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 2 hours. The dispersion obtained contains exfoliated and dispersed nanofibers (chopped) and remains stable for months, whence a yield estimated at 100%. The suspension is then filtered and dried for 24 hours at room temperature, and then for 2 hours at 130° C. The product obtained is presented in the TEM images (FIG. 17). The XPS and TGA analyses show that the product obtained has a higher degree of graphitization (FIG. 18A) than that of the starting CNFs. The TGA and XPS results collected show that the combustion temperature increases and reveals a decrease in the oxygen content after the ultrasonication treatment. The O/C ratio is 0.083 and 0.022 for CNF and CNF-HEM, respectively. Analysis of the temperature-programmed desorption shows that the type of group in the two samples changes (FIG. 18B). The specific surface area of this material measured via the BET method is 135 m²/g as opposed to 154 m²/g for the starting carbon nanofibers.

The CNF-HEM nanocomposite was also used as catalyst in the dehydrogenation reaction of ethylbenzene to styrene. The catalytic tests performed as a function of flow time show that the CNF-HEM nanocomposite is very efficient, with a conversion of 32% and a selectivity of 99%, compared with the starting catalyst based on starting nanofibers which has a conversion of 10% and a selectivity of 93% (FIG. 19).

The catalytic tests were performed with 300 mg of catalysts and a volume-based ethylbenzene concentration of (2.8%) with a helium flow rate of 30 ml/min at 550° C., at atmospheric pressure. The reagents and products were analyzed online by gas chromatography.

The activity for the dehydrogenation of ethylbenzene to styrene of the CNF-HEM catalyst was also compared with commercial iron-based catalysts and also with nanodiamond which is currently the most active metal-free catalyst known in the literature (FIG. 20).

### Example 10—CNF-FLG-HEM Nanocomposite

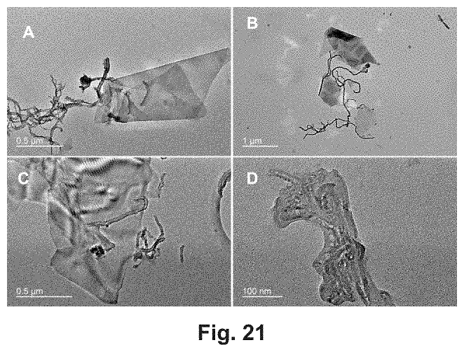

150 mg of CNF, 150 mg of EG and 30 mg of HEM are added to 300 ml of distilled water in a 600 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 2 hours. The dispersion obtained contains a nanofiber/multilayer graphene/hemoglobin nanocomposite (FIG. 21).

### Example 11—FLG-Maltodextrin Nanocomposite

300 mg of EG and 30 mg of maltodextrin are added to 300 ml of distilled water in a 600 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 2 hours.

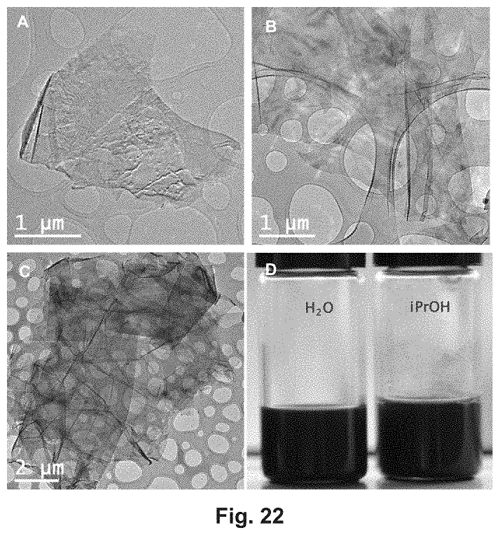

a) the mixture obtained is centrifuged at a speed of 5500 rpm. The supernatant containing the FLG-maltodextrin nanocomposite (FIG. 22—TEM micrographs) is then separated from the bottom, filtered off and dried at 80° C. under vacuum for 2 hours. The product obtained is redispersed in isopropanol (FIG. 22).

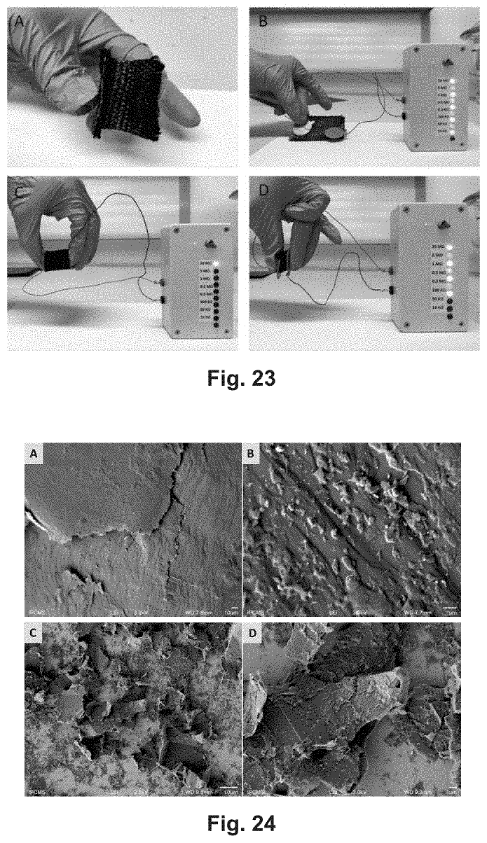

b) the mixture obtained is left to stand for 1 day. The supernatant fraction is then separated out and used to make a deposit of conductive layer on insulating materials. An illustration of this type of material deposited very uniformly on a “zetex” fabric (smart or reinforced textiles) and a three-dimensional polyurethanes foam (sensors) is shown in FIG. 23.

### Example 12—FLG-HEM-5h Nanocomposite

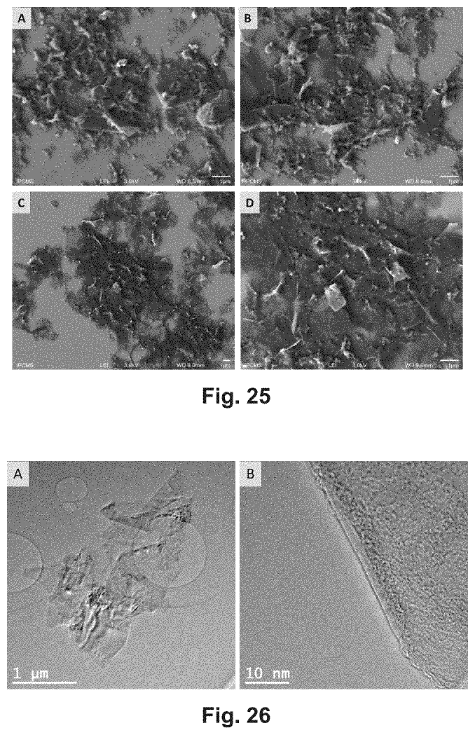

300 mg of graphite and 30 mg of HEM are added to 300 ml of distilled water in a 600 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 5 hours. The mixture obtained is left to decant for 1 day. The supernatant (separated into two fractions) containing the FLG-HEM nanocomposite is separated from the bottom (FIG. 24B, C— bottom). The first 70 ml part, which is a top fraction of the supernatant (FIG. 25 C, D), and the second 70 ml part is the next fraction which is below the first fraction (FIG. 25 A, B). The second fraction contains a nanocomposite with multilayer graphene that is thicker (with a larger number of layers). This example shows that via a simple decantation based on Arrhenius' law, it is possible to separate the multilayer graphene with a different degree of exfoliation (number of layers) and a different lateral size. The yield calculated for the fraction is 23%.

### Example 13—FLG-Aa Nanocomposite

600 mg of EG and 60 mg of agar-agar (Aa) are added to 300 ml of distilled water in a 600 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 1 hour. The mixture obtained is left to decant for 2 days. The 250 ml of supernatant containing the FLG-Aa nanocomposite are separated from the bottom. The TEM images of the multilayer graphene obtained in the supernatant (in nanocomposite form) are presented in FIG. 26.

### Example 14—C₅N₄-Maltodextrin Nanocomposite

300 mg of carbon nitride (C₃N₄) and 30 mg of maltodextrin are added to 300 ml of distilled water in a 600 ml beaker. The mixture is subjected to an ultrasound treatment using a Branson Digital Sonifier 450 ultrasonic finger at a frequency of ˜50/60 Hz with a power of 10% of 400 W, and assisted with mechanical stirring for 1 hour.

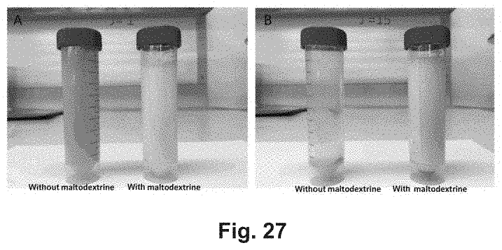

The resulting mixture is transferred into 50 ml pill bottles. FIG. 27 shows the stability of this colloid obtained after leaving to stand for 1 and 15 days, compared with a suspension of C₃N₄ obtained by ultrasonication in the absence of maltodextrin.

### Example 15—FLG-Okra Nanocomposite

10 g of okra are boiled in 300 ml of water for 15 minutes. The solid residue is pressed in order to extract the maximum amount of natural polymolecular system, and separated from the liquid phase. 300 mg of expanded graphite are added to the water containing the natural polymolecular system, and the whole is subjected to an ultrasound treatment using a Branson Digital Sonifier 450 ultrasonic finger at a frequency of ˜50/60 Hz with a power of 10% of 400 W, and assisted with mechanical stirring for 2 hours. The resulting colloid is left to stand for 24 hours. Next, the decanted part and the 200 ml stable part (supernatant) are separated.

### LIST OF REFERENCES

[1] K. Gong, F. Du, Z. Xia, M. Durstock, L. Dai., Nitrogen-Doped Carbon Nanotube Arrays with High Electrocatalytic Activity for Oxygen Reduction, Science 2009, 323, 760-764.
[2] Jian Zhang, Dang Sheng Su, Raoul Blume, Robert Schlögl, Rui Wang, Xiangguang Yang, Andreja Gajovic. Surface Chemistry and Catalytic Reactivity of a Nanodiamond in the Steam-Free Dehydrogenation of Ethylbenzene. Angew. Chem. Int. Ed. 2010, 49, 8640-8644.
[3] Jianxin Geng, Byung-Seon Kong, Seung Bo Yang, Hee-Tae Jung. Preparation of graphene relying on porphyrin exfoliation of graphite. Chem. Commun., 2010, 46, 5091-5093.
[4] Jenny Malig, Adam W. I. Stephenson, Pawel Wagner, Gordon G. Wallace, David L. Officer and Dirk M. Guldi. Direct exfoliation of graphite with a porphyrin—creating functionalizable nanographene hybrids; Chem. Commun., 2012,48, 8745-8747.
[5] Fei Liu. Jong Young Choi, Tae Seok Seo, DNA mediated water-dispersible graphene fabrication and gold nanoparticle-graphene hybrid. Chem. Commun. 2010,46,2844-2846.
[6] L. Guardia, M. J. Fernández-Merino, J. I. Paredes, P. Solis-Fernández, S. Villar-Rodil, A. Martinez-Alonso, J. M. D. Tascón. High-throughput production of pristine graphene in an aqueous dispersion assisted by nonionic surfactants. Carbon 2011, 49,1653-1662.
[7] Athanasios B. Bourlinos, Vasilios Georgakilas, Radek Zboril, Theodore A. Steriotis, Athanasios K. Stubos, Christos Trapalis. Aqueous-phase exfoliation of graphite in the presence of polyvinylpyrrolidone for the production of water-soluble graphenes. Solid State Communications 149, 2009, 2172-2176.
[8] H. Yang, Y. Hemandez, A. Schlierf, A. Felten, A. Eckmann, S. Johal, P. Louette, J.-J. Pireaux, X. Feng, K. Mullen, V. Palermo, C. Casiraghi. A simple method for graphene production based on exfoliation of graphite in water using 1-pyrenesulfonic acid sodium salt. Carbon 2013, 53, 357-365.
[9] D. R. Dreyer, A. D. Todd, C. W. Bielawski, Harnessing the chemistry of graphene oxide, Chem. Soc. Rev. 2014, 43, 5288-5301.
[10] R. Rozada, J. I. Paredes, S. Villar-Rodil, A. Martinez-Alonso, J. M. D. Tascón. Towards full repair of defects in reduced graphene oxide films by two-step graphitization, Nano Research 2013, 6(3), 216-233.
“A few-layer graphene-graphene oxide composite containing nanodiamonds as metal-free catalysts” T. T. Thanh, H. Ba, T.-P. Lai, J.-M. Nhut, O. Ersen, D. Bégin, I. Janowska, D. L. Nguyen, P. Granger, C. Pham-Huu. J. Mater. Chem. A 2014, 2, 11349-11357.
[12] F. Smith. Measurement of sheet resistivities with four-point probe. Bell Syst. Tech. Journal. 1958, 711-718.

1. A nanomaterial/natural polymolecular system nanocomposite in which the nanomaterial is an exfoliated and/or dispersed laminar material, of which the size of at least one of the spatial dimensions is between 1 and 100 nm, and the polymolecular system has a hydrophilic/lipophilic balance (HLB)≥8 and is chosen from phosphoglycerides, omega-3 fatty acids, plant extracts (preferably aqueous or aqueous-alcoholic extracts), or biopolymers selected from proteins, polysaccharides or natural gums; with the proviso that when the nanomaterial is graphene (mono-leaflet or multi-leaflet), the natural polymolecular system is not a hydrophobin, lysozyme, a gum arabic, a guar gum, a locust bean gum, a carrageenan, a xanthan gum, or a combination thereof.

2. The nanocomposite as claimed in claim 1, in which the exfoliated and/or dispersed laminar nanomaterial is:
an exfoliated and/or dispersed nanocarbon, for example graphitic, such as graphene, multi-leaflet graphene, carbon nanofibers, nanodiamonds or nanohoms;
a dispersed nitrogen-based nanomaterial such as carbon nitride or boron nitride;
an exfoliated and/or dispersed lamellar inorganic nanomaterial of the family of metal chalcogenides such as WS₂, MoS₂, WSe₂ or GaSe, of semi-metals (for example WTa₂, TcS₂), of superconductors (for example NbS₂, TaSe₂), or else of topological insulators and thermoelectric materials (for example Bi₂Se₃, Bi₂Te); or
a silicon-based dispersed pseudo-graphitic nanomaterial such as silicon carbide; or
a dispersed laminar mineral such as:
clay, potter's clay, gypsum, muscovite, calcite, galene, halite;
laminar oxides, such as V₂O₅, MoO₃, MnO₂, LaNb₂O₇,TiO₂;
lamellar phyllosilicates, such as talc (Mg₃Si₄O₁₀ (OH)₂), micas and montmorillonite;
lamellar oxides of general formula AxMO₂, in which A=alkali metal ion, M=transition metal element and x is between 0.5 and 1 (NaxMO₂, NaWVO₂, LiCoO₂),
lamellar perovskite oxides such as M[La₂Ti₃O₁₀] in which M=Co, Cu, Zn,
lamellar double hydroxides such as Mg₆Al₂(OH)₁₆),
lamellar metal halides such as Cdl₂, MgBr₂.

3. The nanocomposite as claimed in claim 1 or 2, in which the natural polymolecular system is:
a protein chosen from hemoglobin, myoglobin or bovine serum albumin;
a polysaccharide chosen from maltodextrin, pectins such as pectin E 440, alginates or gelatin;
lecithin, casein or chitin;
a natural source of omega-3 fatty acid chosen from a fish liver oil, such as cod, sardine, salmon or herring liver oil, or a linseed or rapeseed oil;
an extract of okra or an extract of the ground fruit and leaves of African baobab;
a gum chosen from gum tragacanth, karaya gum, tara gum, gellan gum, konjac gum or agar-agar.

4. The nanocomposite as claimed in any one of claims 1 to 3, in which the natural polymolecular system is nonionic.

5. A colloid of nanomaterial/natural polymolecular system nanocomposite in a polar solvent, in which the concentration of exfoliated/dispersed nanomaterial in the polar solvent is ≥1 g/L, and in which the nanomaterial is an exfoliated and/or dispersed laminar material, of which the size in at least one of the spatial dimensions is between 1 and 100 nm, and the natural polymolecular system has a hydrophilic/lipophilic balance ≥8 and is chosen from phosphoglycerides, omega-3 fatty acids, plant extracts, or biopolymers selected from proteins, polysaccharides or natural gums.

6. The colloid as claimed in claim 5, in which the nanomaterial is as defined in claim 2, and the natural polymolecular system is as defined in claim 3 or 4; preferably, the natural polymolecular system is hemoglobin, myoglobin, bovine serum albumin, maltodextrin, agar-agar or an extract of okra or of the ground fruit and leaves of African baobab.

7. The colloid as claimed in claim 5 or 6, in which the polar solvent is H₂O, a C1 to C8 and preferably C2 to C4 alcohol, or a mixture thereof; preferably H₂O, i-PrOH, or a mixture thereof; preferably H₂O.

8. The colloid as claimed in any one of claims 5 to 7, which is in emulsion, gel, suspension or solution form.

9. A process for preparing a nanocomposite colloid as claimed in any one of claims 5 to 8, comprising the exfoliation and/or dispersion of a laminar material in a polar solvent in the presence of a natural polymolecular system with a hydrophilic/lipophilic balance ≥8, under the action of a source of shear forces, preferably coupled with mechanical stirring, for 5 minutes to 50 hours, preferably for 15 minutes to 5 hours, more preferentially for 1 to 3 hours.

10. A process for exfoliating and/or dispersing a laminar material, characterized in that it comprises the exposure of a laminar material to a source of shear forces, preferably coupled with mechanical stirring, for 5 minutes to 50 hours, preferably for 15 minutes to 5 hours, more preferentially for 1 to 3 hours, in a polar solvent in the presence of a natural polymolecular system with a hydrophilic/lipophilic balance ≥8.

11. The process as claimed in claim 9 or 10, in which:
a) the laminar material is
a laminar carbon-based material such as graphite which is preferably expanded, carbon nanofiber bundles, nanodiamonds or nanohoms;
a laminar nitrogen-based material such as carbon nitride or boron nitride;
a silicon-based pseudo-graphitic carbon-based material such as silicon carbide:
a lamellar inorganic material of the family of metal chalcogenides such as WS₂, MoS₂, WSe₂ or GaSe, of semi-metals (for example WTa₂, TcS₂), of superconductors (for example NbS₂, TaSe₂), or else of topological insulators and thermoelectric materials (for example Bi₂Se₃, Bi₂Te): or
a laminar mineral such as:
clay, potter's clay, gypsum, muscovite, calcite, galene, halite;
laminar oxides, such as V₂O₅, MoO₃, MnO₂, LaNb₂O₇, TiO₂;
lamellar phyllosilicates, such as talc (Mg₃Si₄O₁₀ (OH)₂), micas and montmorillonite;
lamellar oxides of general formula AxMO₂, in which A=alkali metal ion, M=transition metal element and x is between 0.5 and 1 (NaxMO₂, NaxVO₂, LiCoO₂),
lamellar perovskite oxides such as M[La₂Ti₃O₁₀] in which M=Co, Cu, Zn,
lamellar double hydroxides such as MgeAl₂(OH)₁₆),
lamellar metal halides such as Cdl₂, MgBr₂;
b) the natural polymolecular system is as defined in claim 3, preferably hemoglobin, myoglobin, bovine serum albumin, maltodextrin, agar-agar or an extract of okra or of the ground fruit and leaves of African baobab;
c) the polar solvent is as defined in claim 7.

12. The process as claimed in claim 9 or 10, in which the source of shear forces is a sonicator, an emulsifying machine, a homogenizer or a turbulence or vibration generator, or a mechanical stirrer; preferably, the source of shear forces is a sonicator, such as an ultrasonic bath or an ultrasonic finger, assisted with a mechanical stirrer.

13. The process as claimed in any one of claims 9 to 12, in which at least two natural polymolecular systems of different hydrophilic/lipophilic balance (HLB) are used.

14. The process as claimed in any one of claims 9 to 13, in which at least two different laminar materials are used.

15. The process as claimed in any one of claims 9 to 14, also comprising a step of isolating the colloid obtained, such as filtration, decantation and/or centrifugation, or another step allowing the separation of components of the colloid having different morphologies, for example multilayer graphene of varied layer size and/or number.

16. The process as claimed in any one of claims 9 to 15, in which the exfoliation and/or dispersion under the action of a source of shear forces is performed in the presence of:
at least one metal salt, such as iron nitrate;
at least one source of dopant, such as nitrogen, boron or sulfur,
at least one pore-forming agent, such as polystyrene beads;
at least one water-soluble polymer, or at least one monomer of a water-soluble polymer such as PMMA, polyethylene oxide, polyacrylamide, PVP, latex, PVA, PEG;
a pH modifier, such as NaOH, KOH or inorganic acids, under conditions that do not lead to hydrolysis or degradation of the natural polymolecular system and/or of the nanocomposite.

17. The process as claimed in any one of claims 9 to 16, also comprising a non-chemical separation step, such as decantation, centrifugation, a source of vibration or by combustion.

18. The process as claimed in any one of claims 9 to 17, also comprising a step of concentrating the colloid obtained, drying the nanocomposite, and optionally redispersing the nanocomposite in a polar solvent.

19. The process as claimed in any one of claims 9 to 18, also comprising a step of calcination at a temperature T≥200° C. under an inert atmosphere or between 60 and 600° C. under an oxygenated atmosphere (air, oxygen).

20. The process as claimed in any one of claims 9 to 18, also comprising a step of separating out or destroying the natural polymolecular system of the colloid, for example by acidic or basic hydrolysis, and of separating out the solvent.

21. A nanocomposite or nanocomposite colloid that may be obtained via a process as claimed in any one of claims 9 to 19.

22. Use of a nanocomposite or nanocomposite colloid as claimed in any one of claims 1 to 8, 18, 19, 20 and 21:
for the manufacture of inks,
for the manufacture of conductive films, of conductive coatings such as a conductive paint, or in the manufacture of electrodes,
for the formation of conductive networks, for example by self-assembly,
for the manufacture of energy storage systems, or in applications in batteries, supercapacitors, and in magnetism,
as catalysts such as metal-free catalysts for the selective dehydrogenation of ethylbenzene or styrene, or as a catalytic support, or
as an additive in polymers, in composite materials, in the production of layers for mechanical reinforcement, in tribology.
